(19) United States
(12) Patent Application Publication
(10) Pub. No.: US 2005/0034877 A1
(43) Pub. Date: Feb. 17, 2005

(54) Light-weight, flexible horseshoes and method

(76) Inventor: Lyle E. Bergeleen, Spokane, WA (US)

Correspondence Address: James R. Haller;Fredrikson & Byron, P.A., 4000 Pillsbury Center, 200 South Sixth Street, Minneapolis, MN, 55402-1425, US

(21) Appl. No.: 10/631,982

(22) Filed: Jul. 31, 2003

(51) Int. Cl. A01L 1/04

(52) U.S. Cl. 168/6

(57) ABSTRACT

A lightweight, flexible, horseshoe and method for fitting it to a horse's hoof. The horseshoe has a body made of ultrahigh molecular weight polyethylene, the body carrying an internal springy metal insert having sufficient resilience to enable the body to flex outwardly when weight is placed on a shod horse's hoof, and to resiliently return to substantially its initial configuration when weight is relieved from the hoof.

### FIELD OF THE INVENTION

The invention relates to a light-weight horseshoe that is capable of flexible movement as the hoof shod with the horseshoe flexes during walking or running.

### BACKGROUND OF THE INVENTION

Horseshoes have been used for centuries to provide protection and to enhance performance of horses. Current horseshoes for the most part made of metals such as steel and aluminum alloys, the latter being preferred for racing from the standpoint of expense and low weight. Horses commonly are reshod every four to five weeks when they are engaged in training or racing.

Unshod horses hooves exhibit a limited expansion or outward movement of the hoof as the hoof contacts the ground and weight is put upon it. When weight is removed, as when the hoof is raised from the ground, it resumes its original, compact configuration.

It has been the desire of many farriers and horseshoe designers to provide a horseshoe that mimics to some extent the movement of a horse's hoof during walking or running. Reference is made to U.S. Pat. No. 6,076,607 (Bergeleen), which shows a horseshoe having a selectable centerpiece enabling the flexibility of the shoe to be adjusted. U.S. Pat. No. 6,082,462 (Lyden) describes a horseshoe that can be made of flexible and relative inflexible materials and which can include a resilient pad for attenuating shock and vibration. U.S. Pat. No. 6,443,232 describes a horseshoe having shock-absorbing qualities, the shoe having a resilient polymer that is sandwiched between metal plates. Yet another horseshoe reportedly having excellent adherence and gripping effect over any kind of ground is described in U.S. Pat. No. 5,988,288 (Bourdieu). Here, a rigid core piece may be partially coated or encased in a rubber compound.

### BRIEF DESCRIPTION OF THE INVENTION

The present invention provides a horseshoe that is of light weight and that is sufficiently flexible and resilient as to flex with a horse's hoof as it becomes weight bearing (as when it strikes the ground) and to resume its initial configuration when weight is removed, as when the hoof is lifted from the ground. The horseshoe comprises a body made of a molded, flexible polyolefin plastic such as polyethylene or polypropylene, and preferably of molded ultrahigh molecular weight polyethylene, the body having an insert of a springy metal that enables the shoe to expand as a horse's hoof to which the shoe is attached expands as the hoof is pressed against the ground, and to contract to essentially its initial configuration as the pressure of the hoof on the ground is released.

In one embodiment, the invention relates to a horseshoe capable of flexion with the hoof of a horse, the horseshoe comprising side portions and a forward portion bridging forward ends of the side portions to provide the shoe with a generally “U” or horseshoe-shaped configuration. The horseshoe includes a molded body comprising one or more polyolefin polymers and preferably ultrahigh molecular weight polyethylene, the body having, as an insert, an elongated, springy metal member having sufficient resilience as to enable the shoe to expand in its plane as a horse's hoof to which the shoe is attached expands or splays outwardly as the hoof is pressed against the ground, and to contract to essentially its initial configuration as the pressure of the hoof on the ground is released. Desirably, the shoe includes a molded-in, perforated screen or mesh of steel, aluminum or other metal to add rigidity to the shoe and to constrain the shoe to movement in one plane.

In another embodiment, the invention involves a method for shoeing a horse. The horseshoe is provided with a molded body comprising one or more polyolefin polymers and preferably ultrahigh molecular weight polyethylene. The shoe includes an insert of a springy metal rendering the horseshoe sufficiently resilient as to expand and contract with a horse's hoof with which the horseshoe is shod. The horseshoe may be manually bent by the farrier beyond the elastic limit of the metal insert to reshape the shoe to fit a particular hoof.

### DESCRIPTION OF THE DRAWING

FIG. 1 is a perspective view of a horseshoe of the invention;

FIG. 2 is a cross-sectional view of an embodiment of a horseshoe of the invention;

FIG. 3 is a cross-sectional view taken along line 33 of FIG. 1;

FIG. 4 is a cross-sectional view of a modified embodiment of a horseshoe of the invention;

FIG. 5 is a top view of a horseshoe of the invention, showing an insert in phantom lines;

FIG. 6 is a top view of an embodiment of an insert useful in horseshoes of the invention; and

FIG. 7 is a broken-away view of an embodiment of the invention.

### DETAILED DESCRIPTION

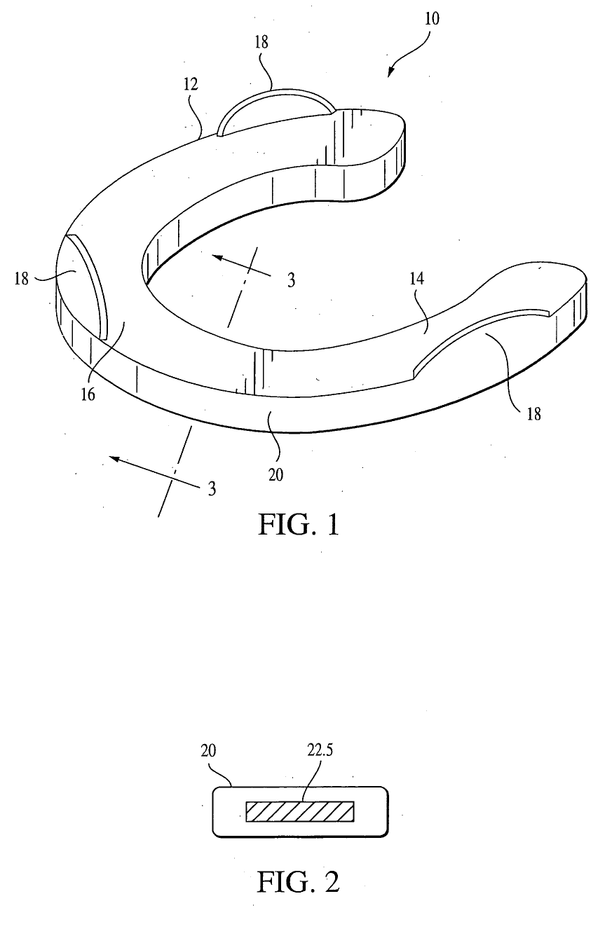

With reference to FIG. 1, a horseshoe of the invention is shown at 10, the horseshoe having side portions 12, 14 and a forward portion 16 bridging forward ends of the side portions. In the embodiment of FIG. 1, upwardly extending toe clips 18 are shown, these clips arising from the side portions and the forward portion and adapted to fit over and against adjacent portions of a horse's hoof. The clips 18 converge upwardly so as to grip the edges of the hoof.

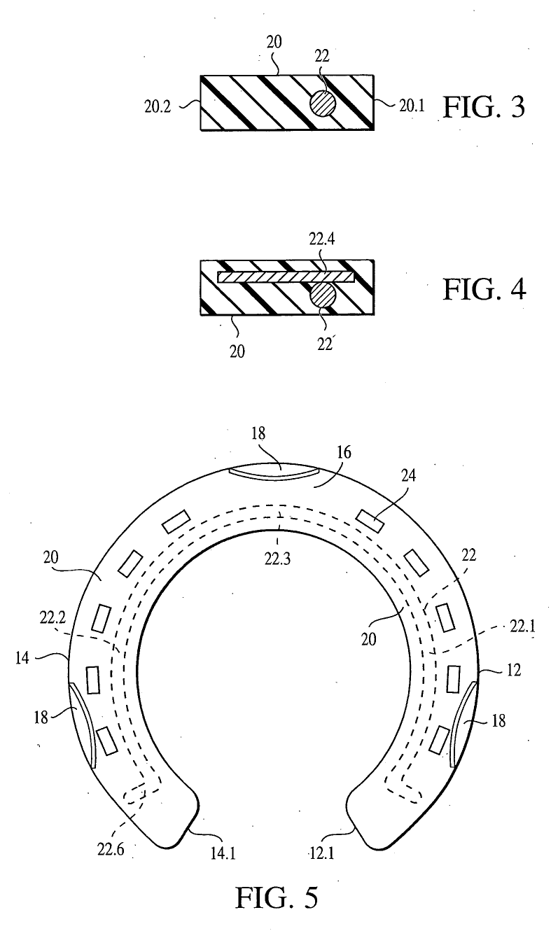

The body 20 of the horseshoe comprises one or more polyolefin plastics, preferably ultrahigh molecular-weight polyethylene. As shown in FIGS. 3 and 5, a springy metal insert 22 is provided within the body. It's overall shape is similar to that of the body 20, and the insert thus is generally “U”-shaped and extends throughout at least most of the length of the body. As shown in FIG. 5, the insert may terminate at a position spaced from the ends 12.1, 14.1 of the body. In a manner similar to that of the body, the insert thus can be said to have side portions 22.1, 22.2 (FIG. 5) and a forward portion 22.3 bridging the side portions of the insert at their forward ends.

The Body

The body 20 of the horseshoe of the invention comprises one or more polyolefin polymers such as polyethylene or polypropylene or mixtures thereof. Ultra-high molecular weight polyethylene (“UHMWPE”) is preferred, and for brevity the horseshoe body is described in particular detail below as being made from this preferred material. UHMWPE is known for its durability; it is a hard, tough material that is molded only with some difficulty. As desired, the ultra high molecular weight polyethylene can be filled with fibers or other fillers as desired to improve strength, but unfilled UHMWPE provides excellent properties and is preferred. UHMWPE commonly is supplied in powder or flake form. It is a difficult material to mold into intricate shapes, and is commonly provided in the form of molded plates or rods from which parts may be machined.

The UHMWPE horseshoe bodies of the present invention are molded using a molding technique in which the molding pressure is closely controlled while the mold is in a temperature range that is above a temperature 25 degrees F. below the highest molding temperature that is used.

The surface of the insert 22 can be treated or profiled as necessary to improve adhesion between it and the UHMWPE body. Roughening of the surface of the inserts tends to improve adhesion, but may in turn lead to premature failure of the insert through stress propagation. Desirably, the inserts have smooth, notch free surfaces.

By ultrahigh molecular weight polyethylene, reference is made to high density polyethylene polymers having molecular weight succeeding about 3×10⁶. UHMWPE polymers are said to provide abrasion resistance greater than that of any other thermoplastic and the highest impact toughness of any plastic, together with good corrosion resistance and excellent environmental stress crack resistance. The UHMWPE polymers useful in the present in the present invention can include fillers and modifiers as desired, such as graphite or glass fibers and the like. A discussion of UHMWPE appears in the Concise Encyclopedia of Polymer Science and Engineering, John Wiley and Sons, New York, 1990, page 357, which page is incorporated by reference herein. Further information concerning UHMWPE and its processing appears in S. M. Kurtz, The UHMWPE Lexicon: An Online Reference, Implant Research Center, School of Biomedical Engineering, Science, and Health Systems, Drexel University, the contents of which are also incorporated herein by reference.

The molding technique that has been found useful for horseshoe bodies of the invention is a compression molding technique in which UHMWPE particles are introduced into an open mold and distributed so as to fill the mold cavity, thereby requiring little in the way of plastic flow during the molding cycle. One may employ a parting mold within which is supported the springy metal insert. The mold is filled with UHMWPE particles, the mold is closed, and the mold is placed under pressure as the temperature is raised to molding temperature in the range of about 375° F. (about 190° C.). As the polymer particles coalesce, it is important to maintain the pressure within the mold fairly constant, at least within a temperature range within about 25 F degrees (about 14 C degrees) of the highest molding temperature. For example, if the highest molding temperature is 375° F., substantially constant pressure desirably is maintained while the molding temperature is in the range of 350° F.-375° F.

Molding pressures in the range of 1500 psi are appropriate. As the temperature of the mold is increased and fusion of the UHMWPE particles occurs, followed by cooling of the mold, volumetric changes in the polymer require the mold parts to be adjusted with respect to another in order to maintain the desired pressure, and this can be accomplished through the use of commercially available hydraulic servomechanisms.

The Insert

Although reference has been made to FIGS. 3 and 5 as showing an insert 22 in the form of an elongated rod that is circular in cross section, it should be understood that the insert may be a single rod of any desired cross section and also multiple rods which may or may not contact one another. Moreover, the insert may be of any desired cross section. FIG. 2 shows an insert 24.5 that is generally rectangular in cross section. As shown in FIG. 4, a rod 22 may be employed in conjunction with a metal plate or screen 22.4 to form the insert. In a desired embodiment, the screen is in the form of a mesh or other perforated metal member made preferably of steel or aluminum, and is employed as an internal stiffener to provide additional strength and rigidity to the body and to restrain the body from movement other than in its plane.

The springy metal insert employed in the invention is capable of resiliently flexing and substantially returning to its initial position within its Hooke's Law range, so that when a horseshoe of the invention is mounted to a horse's hoof, the horseshoe itself may expand and contract as the hoof, during a stride, comes into weight bearing contact with the ground and then is relieved of the weight. Preferably, the springy metal insert also is capable of being bent beyond it's elastic limit, that is, beyond it's Hooke's Law region, such that a farrier may manually bend a horseshoe of the invention to appropriately fit a hoof. Spring steel of the medium or high carbon variety is the springy metal of choice.

Dimensions

From the above discussion, it should be evident that the dimensions of the UHMWPE body and of the insert must be such as to enable the horseshoe to flex outwardly as weight is put on a horse's hoof, and to flex inwardly as the weight is relieved. The UHMWPE, which desirably completely encloses the springy metal insert, must be dimensioned so that it can flex sufficiently to follow the expansion and contraction of a horse's hoof. If the width or thickness of the horseshoe is too great, it's ability to flex readily may be compromised.

Similarly, the dimensions of the springy metal insert must be such that the insert will allow the horseshoe to expand slightly as weight is put upon a horse's hoof, but yet maintain sufficient resiliency to cause the horseshoe to return to substantially it's original configuration once weight is removed from the hoof. That is, the insert must be sufficiently strong as to pull the UHMWPE body back into its original configuration when weight on the hoof is relieved. Of course, the dimensions of the springy insert will depend upon the springy nature of the metal, particularly upon it's modulus of elasticity.

In a preferred embodiment, the dimensions of the UHMWPE body and the dimensions and springy characteristics of the insert are so chosen that not only does the horseshoe return to its initial configuration during use, as discussed above, but also the horseshoe is sufficiently flexible so that a farrier, by hand, may compress the ends of the horseshoe toward one another, or pull them apart, to the extent that the metal insert takes a permanent set, thus enabling the horseshoe to be fitted to different sized hooves.

Configurations

As shown in FIG. 3, an insert typified as a single metal rod 22 is completely embedded within the UHMWPE body 20. Desirably, the insert is positioned nearer the inner wall 20.1 of the body than the outer wall 20.2. The rod 22 may have outwardly turned ends, as shown at 22.6 in FIG. 5, this configuration serving to lock the ends of the insert longitudinally so as to restrain any longitudinal movement between the insert and the UHMWPE body. FIG. 7 typifies another embodiment in which the ends of the insert are turned inwardly, rather than outwardly, and in which the ends of the UHMWPE body terminate in convergent protrusions 20.3. If desired, the ends 20.3 of the body may include bosses enabling the ends to be resiliently joined together across the open end of the horseshoe.

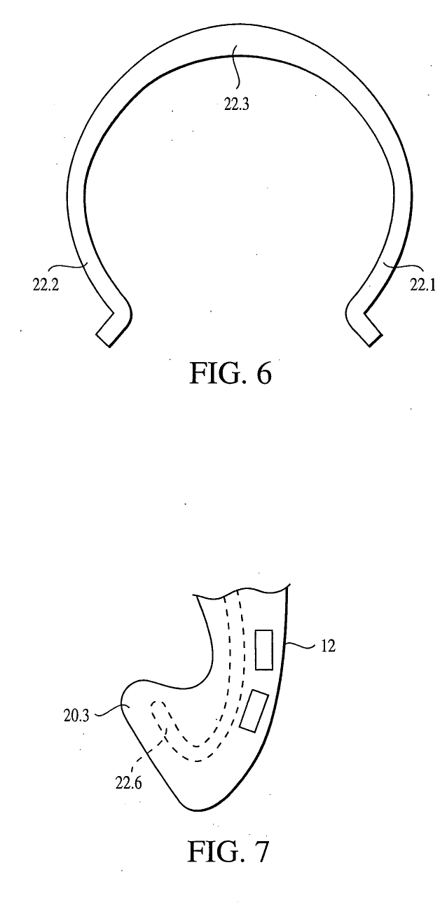

Desirably, the insert 22 is of uniform cross section throughout its length. However, as desired, the insert may be non-uniform in cross section. This is typified in FIG. 6, in which the legs 22.1, 22.2 of the insert are of a circular cross section having a radius that increases toward the forward portion 22.3. It will be understood that the side portions of the resulting horseshoe may have greater flexibility than the central portion of the horseshoe. The central portion may be of a narrower diameter than the side portions, if desired. It will also be understood now that the insert may take on various cross sections throughout its length. Flexing of the horseshoe as discussed above takes place generally in the plane of the horseshoe. By making the forward portion 22.3 of the horseshoe have a generally rectangular cross section, as shown in FIG. 2, with its greatest dimension lying in the plane of the horseshoe, the central portion becomes much stiffer. By maintaining the side portions of the insert with a circular configuration as shown in FIG. 3, the side portions may be more flexible in the plane of the horseshoe, even though the cross sectional area of the side sections and of the forward section are the same.

Horseshoes of the invention can be nailed to, tied to, or otherwise attached to the hoof of a horse by any of the conventional methods. Shown in FIG. 5 are nailholes 24 through which the horseshoe may be nailed to the hoof. Shown also are hoof clips 18 as discussed above.

Use

In one embodiment of the use of the invention, a farrier may select a horseshoe of the invention, and manually bend it if necessary (using pliers or other instruments) beyond the elastic limit of the insert so that the horseshoe takes on a set in a rest configuration that appropriately fits a horse's hoof. The horseshoe is then affixed to the hoof, as by nailing, and the hoof is trimmed as needed.

While a preferred embodiment of the present invention has been described, it should be understood that various changes, adaptations and modifications may be made therein without departing from the spirit of the invention and the scope of the appended claims.

1. A horseshoe capable of flexion with the hoof of a horse, the horseshoe comprising side portions and a portion bridging the side portions at their ends to provide the horseshoe with a generally U shaped configuration to fit the hoof of a horse, the horseshoe comprising a molded body comprising ne or more polyolefin polymers and having, as an insert, an elongated springy metal member having sufficient resilience as to enable the shoe to expand as a horse's hoof to which the shoe is attached expands as the hoof is pressed against the ground, and to contract to essentially its initial configuration as the pressure on the hoof is released.

2. The horseshoe of claim 1 wherein said body comprises ultra high molecular weight polyethylene.

3. The horseshoe of claim 2 wherein said insert includes side portions extending for a portion of the length of the respective side portions of the body but terminating rearwardly at positions spaced from rearward ends of the side portions of the body.

4. The horseshoe of claim 2 wherein said elongated insert is generally U shaped and is of substantially uniform cross section throughout its length.

5. The horseshoe of claim 2 wherein said insert is generally U-shaped and has a central portion at the front end portion of the body and side portions extending rearwardly from respective ends of the central portion.

6. The horseshoe of claim 5 wherein the bending modulus of elasticity of the central insert portion is different from the bending modulus of elasticity of either of the side insert portions.

7. The horseshoe of claim 5 wherein said insert side portions terminate rearwardly in ends terminating short of the ends of the body side portions.

8. The horseshoe of claim 7 wherein said rearward ends of said side insert portions include portions angled from the length direction of such side insert portions to grip the body of the horseshoe and restrain longitudinal movement of the insert with respect to the body.

9. The horseshoe of claim 2 wherein said body includes a supportive metal mesh insert contributing rigidity to the body and restraining the body from movement other than in its plane.

10. Method of shoeing a horse, comprising
a. providing a horseshoe having a molded body comprising one or more polyolefin plastics and containing a springy metal insert having a predetermined modulus of elasticity and an elastic limit,
b. bending the horseshoe beyond the elastic limit of the insert so that the horseshoe is configured to fit the hoof of a horse, and
c. attaching the horseshoe to the horse's hoof.

11. The method of claim 10 wherein said molded body is formed of ultra high molecular weight polyethylene.
